(19) United States
(12) Patent Application Publication
(10) Pub. No.: US 2011/0076375 A1
(43) Pub. Date: Mar. 31, 2011

(54) ALCOHOL INFUSED ICE CUBE APPARATUS AND METHODS

(76) Inventors: Luke Johnson, St. Cloud, MN (US); Bruce Johnson, Ramsey, MN (US); Joseph Robinson, St. Cloud, MN (US); Brandon Mathiowetz, Minneapolis, MN (US)

(21) Appl. No.: 12/962,253

(22) Filed: Dec. 7, 2010

Related U.S. Application Data
(63) Continuation of application No. 11/842,702, filed on Aug. 21, 2007, now abandoned.
(60) Provisional application No. 60/839,264, filed on Aug. 21, 2006.

(51) Int. Cl. C12G 3/00; B67D 7/78; B67D 7/80; F25C 5/18

(52) U.S. Cl. 426/524; 222/145.6; 222/146.6; 62/344

(57) ABSTRACT

An ice cube machine that generates ice cubes having an alcohol content of at least 2-5%. The ice cube machine operates at temperatures of no greater than 0° F., and typically at least 0° F. or colder. An ice dispensing system monitors the amount of ice cubes dispensed from the machine and can determine the amount of alcohol dispensed from the system.

### CROSS REFERENCE TO RELATED APPLICATIONS

This application is a continuation of application Ser. No. 11/842,702, filed Aug. 21, 2007, which application claims the benefit of provisional application Ser. No. 60/839,264, filed Aug. 21, 2006, which applications are incorporated herein by reference in their entirety.

### BACKGROUND

1. Technical Field

The present disclosure generally relates to ice making machines and methods of making ice cubes, and more particularly relates to ice making machines and related methods for making alcohol infused ice cubes.

2. Related Art

Ice cubes have been made for consumer use for many years. There are a variety of methods and machines for making ice cubes. In a very simplified form, a tray or mold divided into a plurality of sections is filled with water and placed in an environment wherein the temperature surrounding the water is below the freezing point of the water. The water in the trays changes from a liquid form to a frozen, solid form. The frozen water is removed from the tray in the form of some type or style of ice cube. The ice cube can be used for many purposes such as, for example, addition to drinks and cooling foods.

Typically, an ice cube is known to have one of several common shapes including, for example, a cube shape having a rectangular cross section, a crescent shape (i.e., elongate curve-shaped structure), a nugget shape (a cylindrical shape), tubular shape (a hollow cylindrical shape), a chip shape (a flat rectangular shape), or crushed. An “ice cube” as the term is used herein is intended to describe a piece of solidified, frozen liquid having a size or volume of at least about one cubic centimeter (1 cm³) and no greater than about ten cubic centimeters (10 cm³). Preferably, an ice cube as the term is used herein has a size of about 2 cm³ to about 5 cm³.

A variety of ice making machines and methods have been disclosed in the prior art. For example, U.S. Pat. No. 4,901,539 to Garber discloses an ice making and dispensing machine; U.S. Pat. No. 5,394,705 to Torii disclosed a flavored ice and manufacturing method for the same; U.S. Pat. No. 6,513,337 to Astvatsatrian discloses a system for making and dispensing colored water and colored ice cubes of varying shapes; and U.S. Pat. No. 6,672,097 to Ashley discloses a flavored ice cartridge dispenser for ice maker, which patents are incorporated herein by reference. Commercial and consumer ice machines have been manufactured and sold for decades using general principles of ice making.

In the area of food services, beverages are kept cool by refrigeration or ice cubes. A well known dislike among consumers is the dilution of their drink when frozen water (i.e., ice cubes) is added to the drink for the purpose of cooling the drink. As the ice cube melts in the drink to cool the drink, the ice cube changes from its frozen, solid state to a liquid water state. The added liquid water dilutes the drink. This problem is of particular concern when serving alcoholic drinks since the dilution of the alcoholic drink resulting from melted ice cubes reduces the alcohol content of the per unit volume, thus affecting among other things the taste of the drink and the effect of alcohol in the consumer's body.

Addressing these and other concerns related to the use of ice cubes for consumers would be an advance in the art.

### SUMMARY

The present disclosure generally relates to methods and systems for generating alcohol infused ice cubes having a minimum alcohol content. One aspect of the present disclosure relates to an alcohol infused ice making apparatus that includes a cooling source, a liquid mixing solution (water or other mix) input, a liquid alcohol input, an ice mold, an ice cube bin, and a dispenser assembly. The machine mixes the solution and alcohol and then fills the mold with the solution/alcohol mixture. The filled mold is positioned within a refrigerated area, wherein the low temperature is maintained by the refrigeration source. After the solution/alcohol mixture is frozen within the mold, the frozen mixture is removed from the mold and collected in the ice cube bin. The dispenser assembly dispenses the ice cubes from the bin for consumer use.

Another aspect of the present disclosure relates to a method of generating alcohol infused ice cubes having a minimum alcohol content. The method includes mixing liquid solution and alcohol to create a solution/alcohol ratio having an alcohol content of at least 2-5%. The method further includes filling an ice cube mold with the solution/alcohol mixture and freezing the mixture while in the mold. The method still further includes removing the frozen mixture in the form of an alcohol infused ice cube.

Alcohol infused ice cubes offer the opportunity for the consumer to have cool alcoholic drinks with less dilution caused by the ice cube.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that disclosure is not limited to such embodiments.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic diagram illustrating general inventive principles of the present disclosure;

FIG. 2 is a schematic front perspective view of an example alcohol infused ice machine in accordance with inventive principles of the present disclosure;

FIG. 3 is a front perspective view of a cooling device portion of the alcohol infused ice machine shown in FIG. 2;

FIG. 4 is front perspective view of an ice mold assembly portion of the alcohol infused ice machine shown in FIG. 2;

FIG. 5 is a front perspective view of a dispensing system portion of the alcohol infused ice machine shown in FIG. 2;

FIG. 6 is a schematic front view of a drop tray portion of the alcohol infused ice machine shown in FIG. 2;

FIG. 7 is a schematic front perspective view of a dispenser chute portion of the alcohol infused ice machine shown in FIG. 2;

FIG. 8 is a schematic front perspective view of a mixing and distribution system portion of the alcohol infused ice machine shown in FIG. 2;

FIG. 9 is a schematic side view of another example alcohol infused ice machine in accordance with inventive principles of the present disclosure, including multiple mixing chambers;

FIG. 10 is a schematic front view of the example alcohol infused ice machine shown in FIG. 9;

FIG. 11 is a schematic top plan view of a drop tray of the alcohol infused ice machine shown in FIG. 9;

FIG. 12 is a schematic top plan view of an example mixing and distribution system of the alcohol infused ice machine shown in FIG. 9;

FIG. 13 is a schematic top plan view of the alcohol infused ice machine shown in FIG. 9;

FIG. 14 is a schematic side view of another example alcohol infused ice machine in accordance with inventive principles of the present disclosure, including a single mixing chamber;

FIG. 15 is a schematic front view of the example alcohol infused ice machine shown in FIG. 14;

FIG. 16 is a schematic top plan view of a drop tray of the alcohol infused ice machine shown in FIG. 14;

FIG. 17 is a schematic top plan view of an example mixing and distribution system of the alcohol infused ice machine shown in FIG. 14;

FIG. 18 is a schematic top plan view of the alcohol infused ice machine shown in FIG. 14;

FIG. 19 is a schematic side view of another example alcohol infused ice machine in accordance with inventive principles of the present disclosure, including vertically stacked ice cube bins;

FIG. 20 is a schematic front view of the example alcohol infused ice machine shown in FIG. 19;

FIG. 21 is a schematic top plan view of an example mixing and distribution system of the alcohol infused ice machine shown in FIG. 19;

FIG. 22 is a schematic top plan view of the alcohol infused ice machine shown in FIG. 19;

FIG. 23 is a schematic front perspective view of another example alcohol infused ice machine in accordance with inventive principles of the present disclosure, including three alcohol inputs and three dispensers; and

FIG. 24 is a schematic front view of another example alcohol infused ice machine according to inventive principles of the present disclosure.

### DETAILED DESCRIPTION

The present disclosure relates to devices and methods for the production of ice cubes having a minimum alcohol content (i.e., alcohol infused ice cubes). It is well known that consumers use ice in mixed alcoholic beverages. The ice used in mixed alcoholic beverages tends to melt during the process of cooling the beverage, thus diluting the mixed alcoholic beverage. Dilution of a mixed alcoholic beverage results in changes to the taste of the beverage as well as reducing the percentage of alcohol content of the beverage over time. Consumers tend to dislike diluted alcoholic beverages, but do prefer having their alcohol infused beverages kept cold in most instances while consuming the drink. The present disclosure provides a means of maintaining cold alcohol infused beverages while minimizing the amount of dilution of the beverage, and increasing quality.

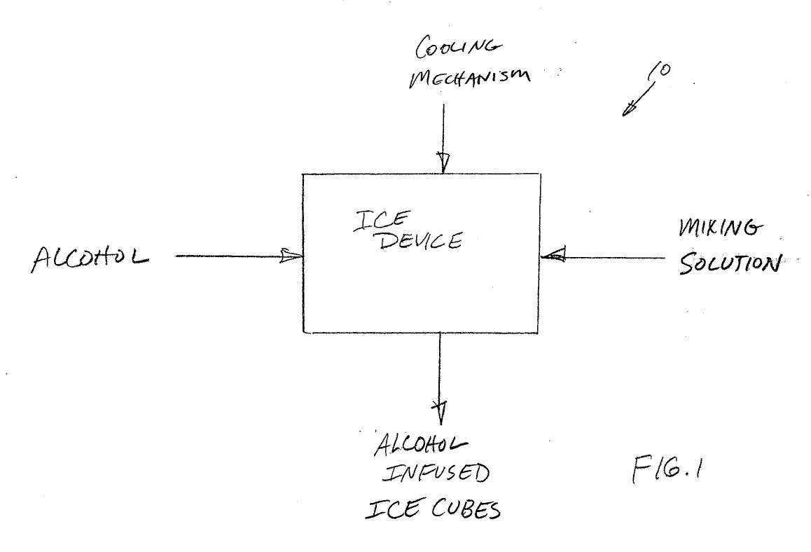

### The Example of FIG. 1

FIG. 1 illustrates schematically an alcohol infused ice machine or device 10. The device 10 has several inputs and an output of an alcohol infused ice cube having a minimum alcohol content. The ice device 10 includes an input of mixing solution, an input of alcohol, and a cooling mechanism. The device 10 mixes the solution and alcohol to create a solution/alcohol mixture having a predetermined alcohol content. The refrigeration input provides temperatures in the device 10 sufficient to freeze the solution/alcohol mixture into an alcohol infused ice cube of predetermined shape and size.

The alcohol infused ice cube is of a sufficient size for consumer use. As described above, a primary consumer use for alcohol infused ice cubes is alcoholic beverages, wherein the ice cubes are used as whole ice cubes within a glass full of alcohol infused beverage. Alternatively, the alcohol infused ice cubes can be crushed and then added to other types of alcoholic beverages to create an alcohol infused drink such as a slush-type drink.

Typically, the temperature of the refrigerated environment needed to freeze solid most types of liquid alcohol drinks is less than about −5° F. Most types of ice making machines used to create ice (e.g., consumer freezers, and consumer and commercial ice machines) operate at a temperature greater than about 0° F. and less than 32° F., and more typically at a temperature of about 5° F. to about 30° F. The ice device 10 described with reference to FIG. 1 preferably operates at a temperature of about 0° to about −60° F., and more preferably about −5° to about −20° F. Some example freezer devices that generate sub-zero degree F. temperatures are blast freezers and freezers operating with liquid Nitrogen. It is recognized that refrigeration/freezing conditions of as low as −300° F. are possible with some types of specialized freezers.

Another commercially available product used to partially freeze alcohol related products are alcoholic slush-type machines. An alcoholic slush machine is used to partially freeze a mixture of solution and alcohol infused beverage to create a partially frozen alcohol infused slush-type beverage. In many cases an alcohol infused slush machine merely freezes the mixing solution portion of the solution/alcohol mixture. The mixing solution molecules are frozen and conglomerate together in small crystals of ice that intermingle with the alcohol in the mixture. Typically, the freezing temperatures used for an alcohol infused slush-type device are well above the low temperatures required to generate solid alcohol infused ice cubes having a predetermined minimum alcohol content.

The predetermined minimum alcohol infused content of the alcohol infused ice cubes disclosed herein, which are generated by, for example, the ice device 10 is at least 2-5% alcohol. In some arrangements, the alcohol infused ice cube devices and methods disclosed herein can generate alcohol infused ice cubes having an alcohol infused content of at least 5-80%, and typically about 5 to about 20% alcohol. Most alcoholic beverages have an alcohol content of no greater than about 80% and typically at least 5%. Some alcoholic beverages must be mixed with water or other mixing solution in order to lower the alcohol content to a level in which the mixture can be frozen into solid ice cubes using commercially viable refrigeration systems. However, it is well within the intent of the present disclosure to provide refrigerated conditions sufficient to freeze alcohol infused ice cubes having an alcohol infused content of up to 100% alcohol.

While the device 10 shown in FIG. 1 includes a mixing solution input, in some arrangements a mixing solution input is not required if the alcohol content of the alcohol drink used as an alcohol input to the device 10 is already of a sufficiently low level to promote freezing of the alcoholic beverage within the preferred refrigeration temperatures (e.g., about 0° to about −60° F.).

### The Example of FIGS. 2-8

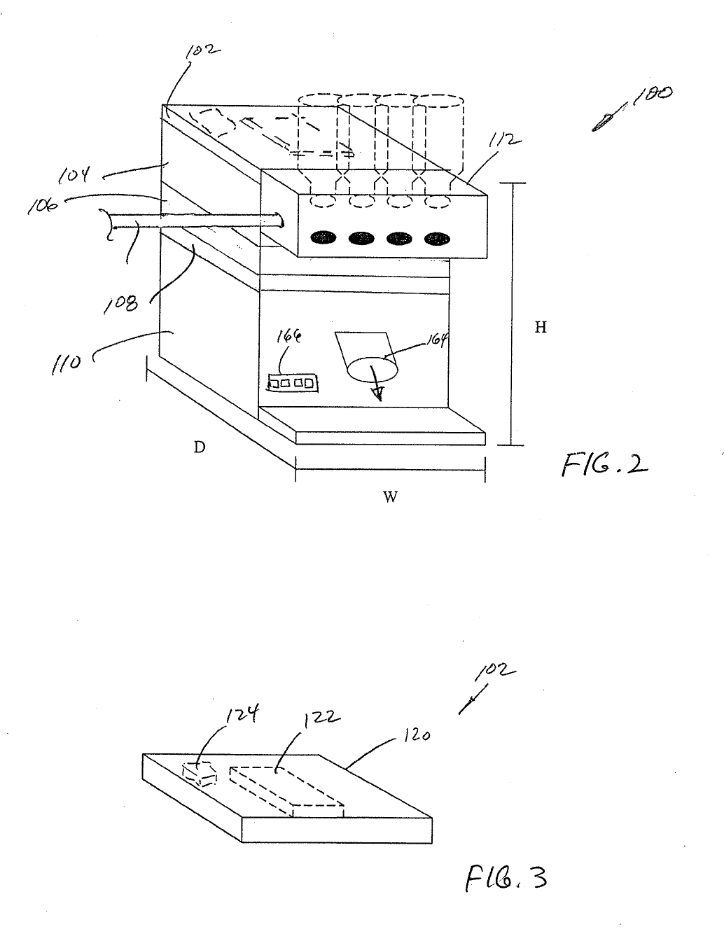

Referring now to FIGS. 2-8, another example alcohol infused ice machine 100 is shown and described. Machine 100 includes a cooling device 102, an ice mold assembly 104, a dispensing system 106, a drop tray 108, a dispense chute 110, and a mixing and distribution system 112. The cooling device 102 is shown in further detail in FIG. 3 to include a cover 120, a refrigerator unit 122, and a blower 124. The refrigerator unit 122 generates cold air that is circulated via the blower 124 into the ice mold assembly 104.

The cover 120 can function as a top cover of the machine 100 to enclose otherwise exposed components of ice machine 100. In other embodiments, the refrigerator unit 122, blower 124 and other components can be positioned at a bottom side of the ice machine 100. Alternatively, at least some of the refrigerator unit 122, blower 124 and other components can be positioned at a location remote from the ice mold assembly 104, dispensing system 106 and other components of the ice machine 100. The refrigerator unit 122 can be any known refrigerator device or system capable of generating the refrigerated environment required for machine 100 to generated alcohol infused ice cubes as described herein.

In other embodiments, the refrigerator 122 can be positioned at other locations in the machine 100. For example, the refrigerator unit 122 can be positioned at a remote location and simply circulate cold air to cool liquid through the ice mold assembly 104 to generate the freezing conditions necessary to freeze a solution/alcohol mixture. The blower 124 may likewise be replaced with other distribution mechanisms for distributing cold air or cold liquid to the ice mold assembly 104. In many configurations, it is advantageous to position the refrigerator or other cold condition generating unit at a vertically upper side of the machine 100 such that cold air at that location permeates downward under natural cold air convection principles. The blower 124 and other features of the machine 100 may require colder temperature ratings in order to properly function under the colder conditions (sub-zero degrees F.) required for freezing solid the alcohol infused ice cubes.

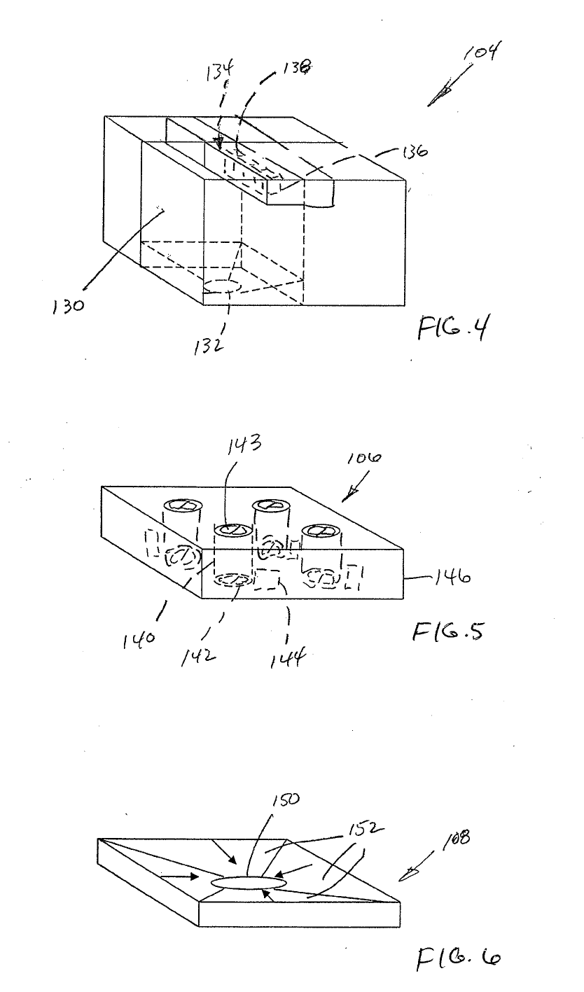

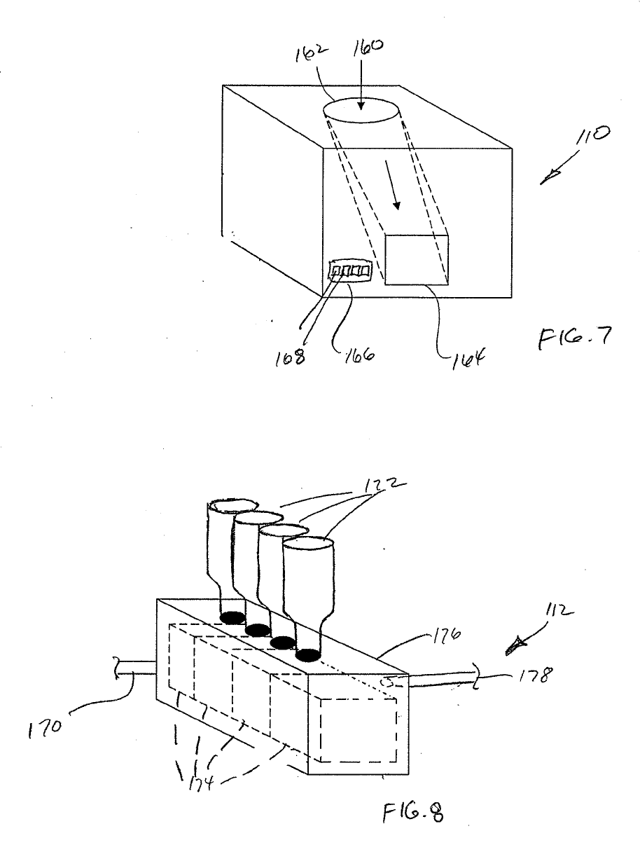

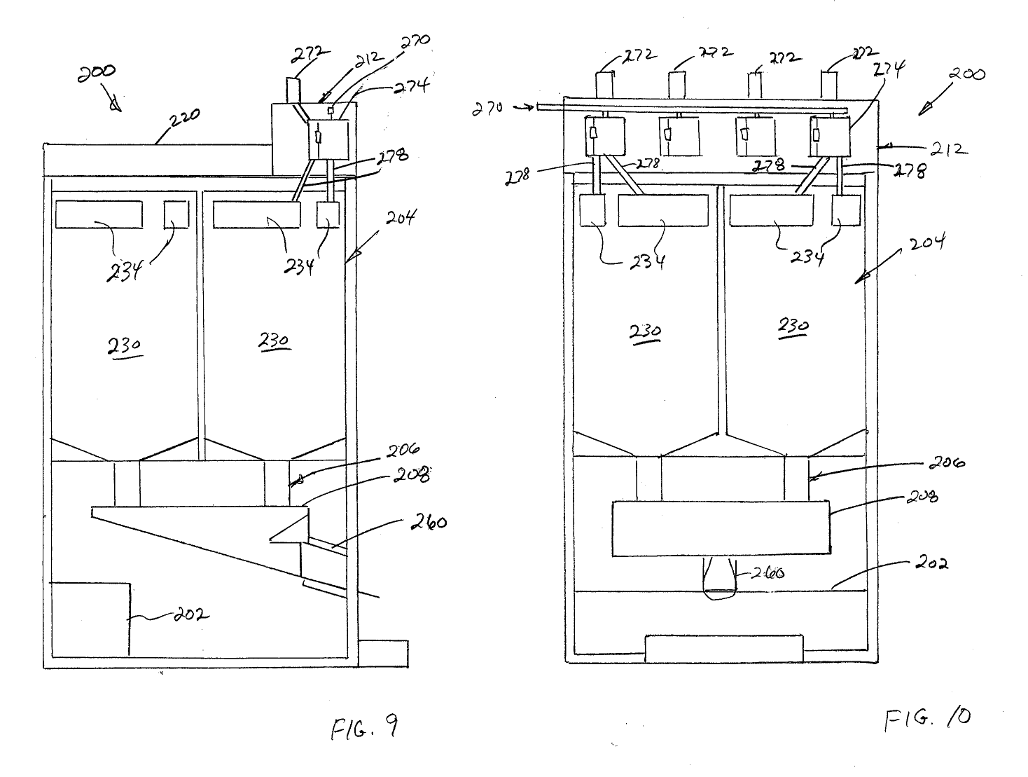

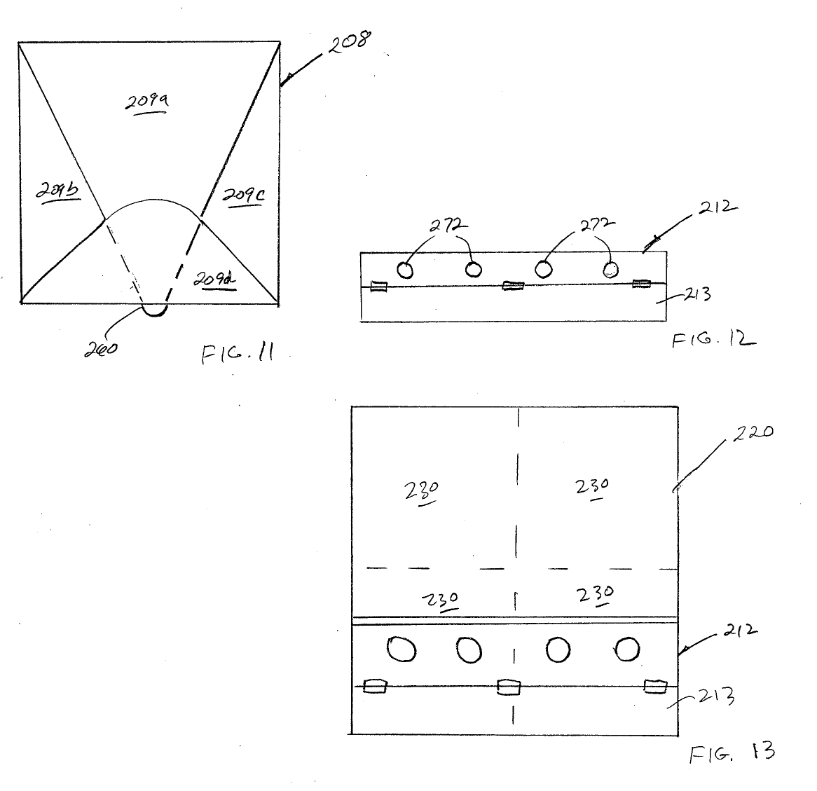

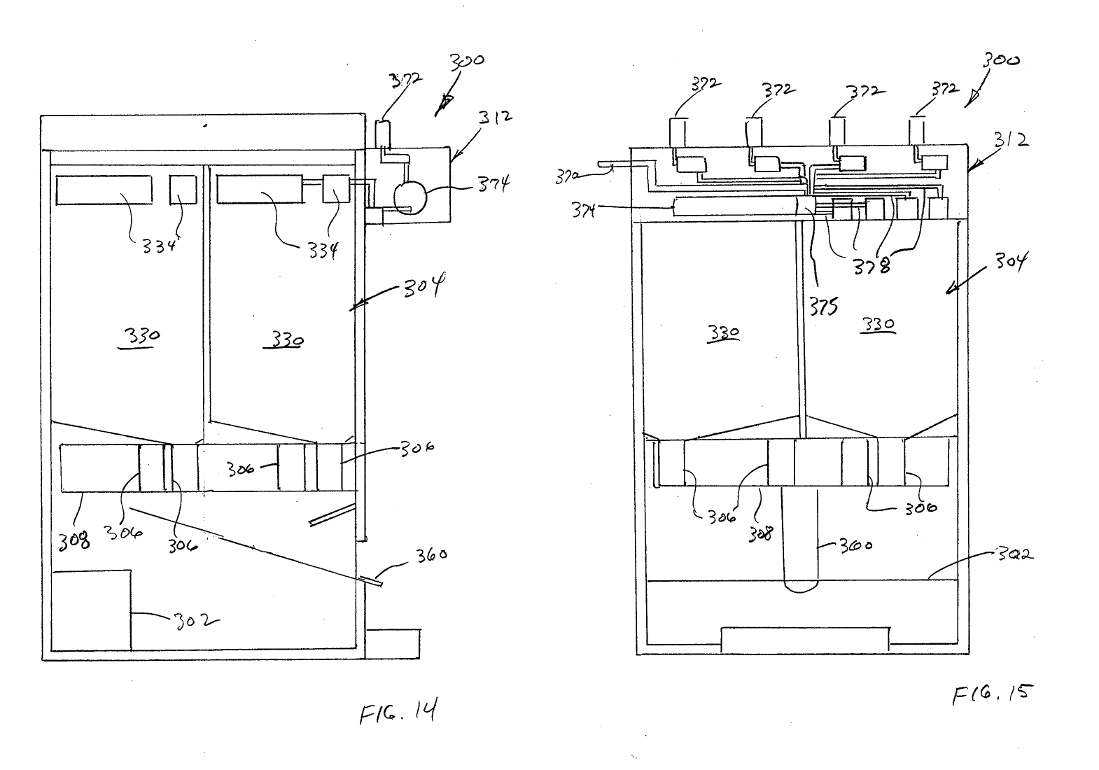

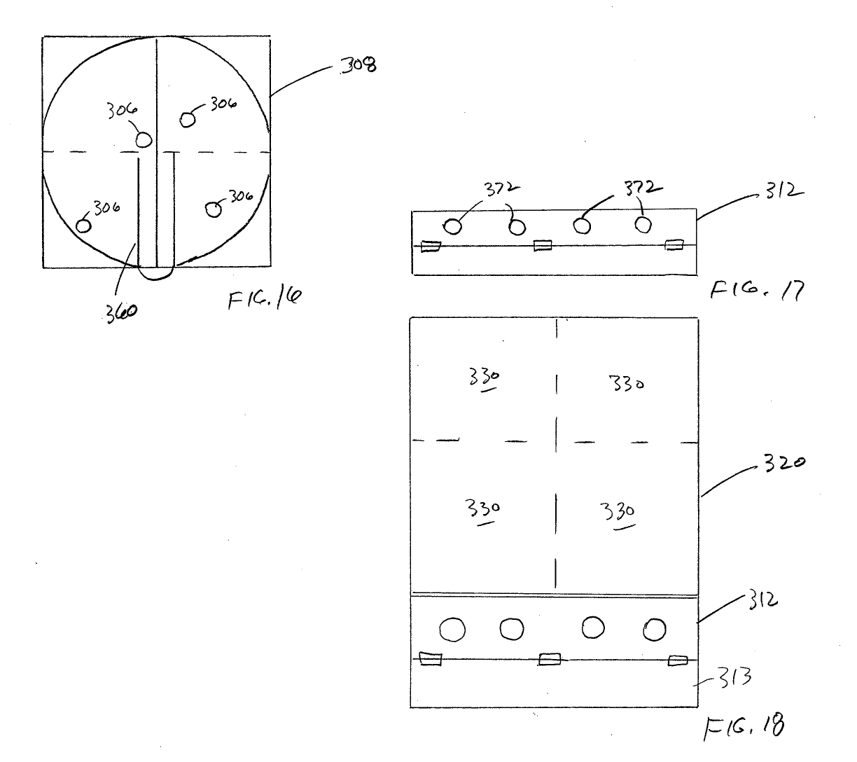

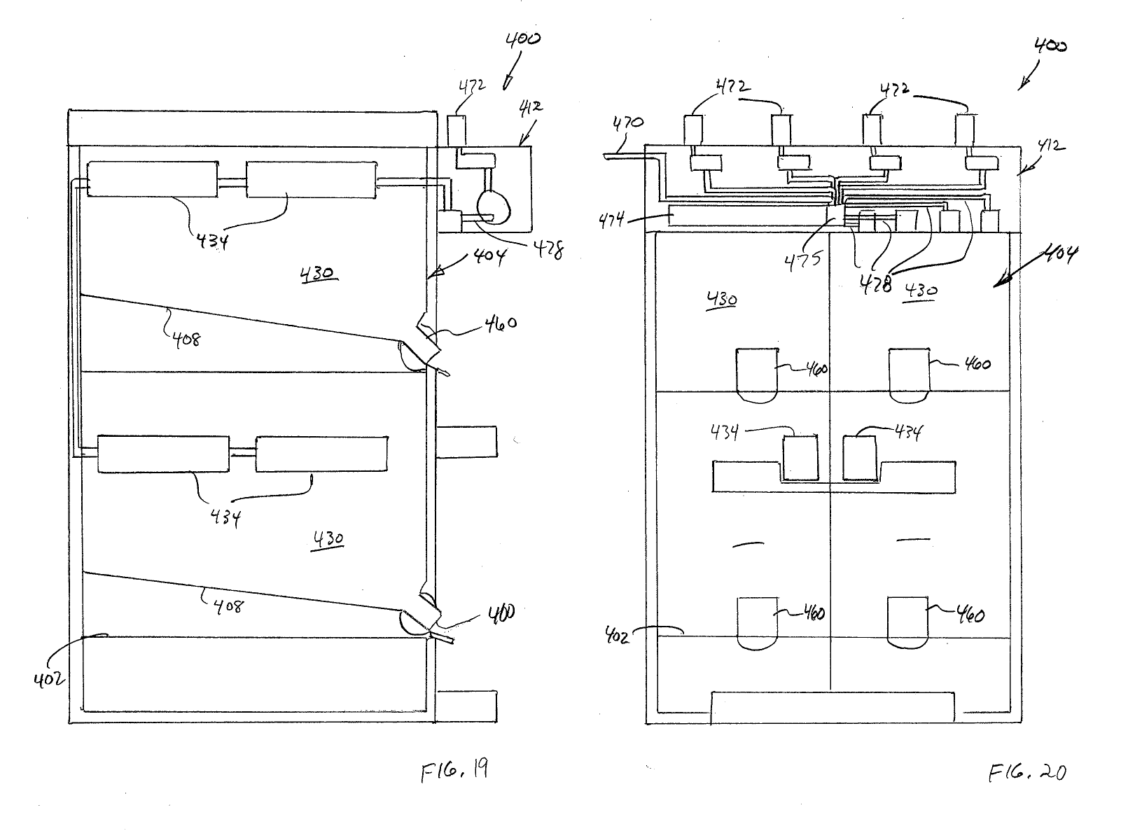

The ice mold assembly 104 is shown in further detail in FIG. 4. The assembly 104 includes a bin housing 130 sized to enclose and retain a plurality of alcohol infused ice cubes, a dispenser opening 132, and an ice maker 134. The ice maker 134 includes a mold 136 having a plurality of partitions 138. The ice maker 134 is typically positioned near a top end of the bin housing 130 such that ice generated in the mold 136 can be extracted and fall under gravity forces into the bin housing 130 where the ice cubes are collected for later dispersion through the dispense opening 132.

The mold 136 can have any of a number of different shapes and sizes to create different shapes and sizes of alcohol infused ice cubes. For example, the mold 136 can have a plurality of partitions 138 that create cube shape, crescent shape, nugget shape, tubular, chip or any other desired shape having any desired size for the alcohol infused ice cubes. Typically, the mold 136 is sized to generate ice cubes having a volume of no less than about 1 cubic centimeter and no more than about 10 cubic centimeters. Ice cubes for consumer use, in particular those for alcoholic beverages, usually have a volume of about 1 cm³ to about 3 cm³. In an alternative configuration, the alcohol infused ice cubes generated by the system 100 are less than 1 cm³ or greater than 10 cm³ in volume, depending on a given application or use for the alcohol infused ice cubes. The ice maker 134 also includes an ice cube remover (not shown) that is used to remove the alcohol infused ice cubes from the mold 136. Typically, an ice cube remover can operate automatically to remove the alcohol infused ice cubes from the ice maker 134 after the alcohol infused ice cubes have been sufficiently frozen to retain their shape and size when collected in the bin housing 130.

The alcohol infused ice cubes generated by the ice maker 134 are frozen to a sufficient solid state and having a hardness and frozen consistency that is similar to frozen pure water ice cubes that are frozen at a temperature of about 0° to about 20° F.

Typically, the alcohol infused ice cubes having the alcohol content described above cannot be crushed or broken under the forces of a human hand. However, such alcohol infused ice cubes when frozen by the ice maker 134 are typically brittle and crack when engaged under large forces with other alcohol infused ice cubes (e.g., those ice cubes being collected in the bin housing 134). Preferably, the bin housing 134 is sized and the alcohol infused ice cubes generated by the ice maker 134 have a sufficient hardness and rigidity to avoid cracking or otherwise breaking into smaller pieces when being collected in the bin housing 130. Alternatively, the bin housing 130 and ice maker 134 and alcohol infused ice cubes are configured such that the alcohol infused ice cubes generated intentionally break into smaller pieces upon collection in the bin housing 130. Intentional breaking of the alcohol infused ice cubes can result from, for example, features of the ice maker 134 or the ice cube remove (not shown, features of the bin housing where the alcohol infused ice cubes are collected, the size and shape of the alcohol infused ice cubes, or the composition of the alcohol infused ice cubes.

The mold assembly 104 is shown including four different compartments, wherein each compartment includes a separate ice maker 134 and bin housing 130. Each of the ice makers 134 and the ice mold assembly 104 is coupled to a different alcohol mixture as will be described below in further detail with reference to the mixing and distribution system 112 shown in FIG. 8. The bin housing 130 can be insulated as necessary to ensure the alcohol infused ice cubes generated in the ice maker 134 and stored in the bin housing 130 maintain their solid frozen state.

Referring now to FIG. 5, the dispensing system 106 is shown and described in further detail. The dispensing system 106 includes an ice chamber 140, a door 142, a controller 144, and a housing 146. The housing 146 has a plurality of ice chambers 140 defined therein. Each of the ice chambers 140 are associated with one of the ice makers and bin housing of the ice mold assembly 104 described above. Typically, the ice chamber 140 is sized to collect a predetermined number of alcohol infused ice cubes generated by the ice maker 134. This predetermined number of alcohol infused ice cubes collected in the ice chamber 140 typically corresponds to, for example, the volume of a glass that will eventually hold the alcohol infused ice cubes for preparation of an alcohol infused beverage that includes the alcohol infused ice cubes. For example, the ice chamber 140 may be sized to retain four ice cubes, wherein each alcohol infused ice cube has a volume of about 1 cm³ if the glass eventually used to retain the alcohol infused ice cubes has a total volume of about 6 cm³ to about 16 cm³.

Separate doors 142, 143 can be positioned at top and bottom ends of the ice chamber 140 so as to improve control of ice cubes retained in the ice chamber 140 and dispersed out of the machine 100 at any given time. The doors 142, 143 can pivot, slide or deform according as needed to provide a controllable opening and closing of access to the ice chamber 140. The doors 142, 143 can move manually, automatically, or in response to actuation from an electronically controlled source such as the controller 144. In a manual arrangement, a separate sliding door or rotational handle can be actuated by an operator to open and close access to the ice chamber 140.

The controller 144 can be used to operate the doors 142, 143 as well as perform and/or control other functions associated with the dispensing system 106. For example, the dispensing system 106 can include mechanisms for counting or weighing the alcohol infused ice cubes as they enter into and/or leave the ice chamber 140. Such weighing or other monitoring means can provide more accurate dispersion of the alcohol infused ice cubes in some cases. In one example, the ice chamber 140 is coupled to a load cell or other weight measuring device that monitors by weight the alcohol infused ice cubes that enter and/or exit the ice chamber 140. In another example, a motion sensor is associated with the ice chamber 140 to monitor by movement the number of ice cubes entering and/or exiting the ice chamber 140.

Referring now to FIG. 6, the drop tray 108 is shown and described. The drop tray 108 includes an ice aperture 150 and a plurality of sloped surfaces 152 directed towards the ice aperture 150. The drop tray 108 is positioned vertically below the dispensing system 106. The sloped surfaces 152 are positioned directly beneath the bottom opening of each of the ice chambers 140 of the dispense system 106 such that when alcohol infused ice cubes drop downward from the ice chamber 140 (e.g., after opening door 142) the alcohol infused ice cubes slide along the sloped surfaces 152 and into the ice aperture 150. One advantage of using the drop tray 108 is that a single ice aperture 150 can be provided for a plurality of different types of alcohol infused ice cubes generated by the machine 100. The ice aperture 150 is coupled in fluid communication with a dispensing channel 160 of a dispense chute 110 as shown in FIG. 7. The channel 160 of the top opening 162 is positioned vertically below the ice aperture 150 of the drop tray 108.

The operator has easy access for dispensing the alcohol infused ice cubes when the opening 164 of the channel 160 is in an opened state and positioned at a front side of the machine 100. The operator can position a glass for containing an alcoholic beverage into which the alcohol infused ice cubes will be placed at the outlet opening 164 prior to dispensing alcohol infused ice cubes through the ice chamber 144, on the sloped surfaces 152 into the ice aperture 150, and through the channel 162 into the glass.

The dispense chute 110 can include a control panel 166 having a plurality of control buttons 168. The control buttons 168, upon activation, can control one or more functions of the machine 100, such as activating at least one of the doors 142, 143 directly or via the controller 144 to release alcohol infused ice cubes for dispensing out of the machine 100. The control panel 166 can include other control buttons for other operations associated with the machine 100. For example, the control panel can be used to modify the operating temperature in the mold assembly 104 for purposes of freezing the solution/alcohol mixture. In another example, the control panel can be used to alter the ratio of mixing solution and alcohol by controlling volume mechanisms in the mixing and distribution system 112 that will be described below.

At least one of the control panel 166 and controller 144 can be used to keep track of the total number of dispenses of alcohol infused ice cubes from the machine 100. Usually, the average amount of alcohol per ice cube is known as part of the mixing function of system 112. Therefore, the total number of alcohol infused ice cubes dispensed can be used to determine the total amount of alcoholic beverage used from the containers 172.

Referring now to FIG. 8, the mixing and distribution system 112 (also referred to as a “tumbler system”) is shown and described in further detail. The system 112 includes a solution input 170, a plurality of alcohol bottles or containers 172 positioned along a top side thereof, a plurality of mixing chambers 174, a housing 176, and a solution/alcohol mixture output 178. The containers 172 are positioned upside down along a top surface of the housing 176. The alcohol beverage contained within the containers 172 is then provided under gravity forces into the mixing chambers 174. A separate mixing chamber can be associated with each of the containers 172. Alternatively, at least some of the containers 172 can provide a source of alcohol beverage to two or more of the mixing chambers. In still other arrangements, multiple containers 172 can provide alcohol beverages to a single chamber 174. The use of multiple containers 172 and multiple mixing chambers in a system 112 provides significant variability and customization in generating alcohol infused ice cubes having the desired alcohol infused content and mixture.

Each of the mixing chambers 174 has associated with it a mixing zone (not clearly illustrated) and some valving mechanisms (not clearly illustrated) that control the flow of alcohol beverage and mixing solution into the mixing zone. The valving mechanisms can operate automatically under pressure forces generally known to exist with a standard solution input and the pressure created by an upside down bottle of alcohol beverage. The valving mechanism can also be controlled by, for example, electronically, magnetically, pneumatically or other type of valving technology in response to control signals generated by, for example, the controller 144 or control panel 166. The solution/alcohol mixture output 178 can be pressurized, metered, and controlled as desired as part of the delivery of the solution/alcohol mixture to the ice maker 134.

The amount and rate of mixing in the mixing chamber 174 can be controlled in part by the amount of alcohol infused ice cubes collected in the bin housing 170. In one example, the number or net volume of alcohol infused ice cubes in the bin housing 170 can be monitored. When a predetermined amount or volume of cubes is reached, the mixing of solution and alcohol in the mixing chamber 174 either stops, is slowed down, or is fed through the output 178 at a slower rate. This feature can help limit overfilling of the bin housing 170 with alcohol infused ice cubes.

A four-chamber, four-container system is shown in FIG. 8. In other arrangements, any number of mixing chambers and alcohol containers can be used in a given alcohol infused ice machine. In one example, it is envisioned that an alcohol infused ice machine include five or more alcohol containers and/or mixing chambers. Such a relatively large machine can be used in large bars and other social establishments that have high volume sales. Alternatively, a single mixing chamber and single alcohol container configuration can be used for a relatively small alcohol infused ice machine for use in a low volume application such as a consumer's home. In another example, the alcohol infused ice machine can be configured to generate, store, and dispense both water ice cubes and at least one type of alcohol infused ice cubes.

The solution input 170 to the system 112 can be connected in fluid communication with, for example, a pressurized water system such as a building fresh water system. Alternatively, the source of water 170 can be connected to bottled water, another source of filtered or stored water, or another solution such as a soft drink, lemonade, or specialty non-alcoholic beverage. The mixture output 178 is coupled in fluid communication with the ice maker 134 of the ice mold assembly 104. The output 178 can include a plurality of separate channels defined therein, wherein a separate channel is associated with each of the mixing chambers 174. Alternatively, a separate mixture output 178 can be associated with each of the mixing chambers 174 and directed along separate paths to the ice maker 134 in each of the bin housings 130 of the ice mold assembly 104.

Any one of the features 102, 104, 106, 108, 110, 112 described above can be modified, replaced, or eliminated while still providing the machine 100 with at least some desired functionality needed to produce alcohol infused ice cubes. For example, the dispensing system 106 and drop tray 108 can be integrated into a single unit rather than being two separate units coupled together. In another example, the dispensing system 106 and drop tray 108 could be eliminated and alcohol infused ice cubes generated by the ice maker 134 dropped directly into the cup of an operator. In another example, the solution/alcohol mixture can be provided from a remote location and delivered directly to the ice mold assembly 104. It is also possible to store the generated alcohol infused ice cubes at a remote location by directing the alcohol infused ice cubes to a separate storage bin where the alcohol infused ice cubes are dispensed. These and many other alternative arrangements fall within the spirit and scope of the present disclosure.

The alcohol infused ice machine 100 in the embodiment shown in FIGS. 2-8 has dimensions that make the machine 100 suitable for use in a residential or retail space. In one example, the height H of the machine 100 can be in the range of about 15 to about 60 inches. The width W of the machine 100 can be in the range of about 12 to about 60 inches. The depth D of the machine 100 can be in the range of about 12 to about 36 inches.

### The Example of FIGS. 9-13

FIGS. 9 and 10 illustrate another example alcohol infused ice machine 200. Machine 200 includes a cooling device 202, an ice mold assembly 204, a dispensing assembly 206, and a mixing and distribution system 212. The system 212 includes a solution input 270, an alcohol input 272, and a mixture output 278. The mixture output 278 is coupled in fluid communication with the ice mold assembly 204. Alcohol infused ice cubes generated by the ice mold assembly 204 can be dispensed from the machine 200 by the dispensing system 206, drop tray 208, and a dispense shoot channel 260.

The machine 200 includes four different alcohol inputs 272 that are coupled to separate mixing chambers 274. Each of the mixing chambers 274 is coupled in fluid communication with the source of mixing solution 270. Each of the mixing chambers 274 is coupled in fluid communication with a set of ice makers 234. The machine 200 includes four separate bin housings 230 that collect alcohol infused ice cubes generated by the sets of ice makers 234.

The drop tray 208 is configured to receive alcohol infused ice cubes stored in each of the bin housings 230 and dispensed the alcohol infused ice cubes from a single dispense shoot channel 260. In other arrangements, a separate dispense shoot channel 260 is provided for each of the bin housings 230. FIG. 11 illustrates the drop tray 208 with the channel 260 integrated therein to dispense alcohol infused ice cubes that fall onto any of the top surfaces 209A-D (see FIG. 11).

The machine 200 includes a solution input 270 that is coupled in fluid communication with each of the mixing chambers 274. In other arrangements, a separate solution input 270 can be provided to each of the mixing chambers 274. As discussed above, the solution input 270 can include any liquid solution such as, for example, water or other nonalcoholic or alcoholic solutions.

FIGS. 12 and 13 illustrate top views of the mixing and distribution system 212 (FIG. 12) or the combination of the system 212 with a top cover 220 of the machine 200. The mixing and distribution system 212 can include a door or other lid member 213 that provides access to the mixing chambers 274 and other internal components of the mixing and distribution system 212.

The machine 200 can further include a control system (not shown) that is used to control at least one function of the machine 200. The control system can be operated using a control panel, switches, actuators, or other user interface.

### The Example of FIGS. 14-18

FIGS. 14 and 15 illustrate another example alcohol infused ice machine 300. The machine 300 includes a cooling device 302, an ice mold assembly 304, a dispensing system 306, and a mixing and distribution system 312. The mixing and distribution system 312 includes a solution input 370, a plurality of alcohol inputs 372, and a mixture output 378. The mixture outputs 378 are coupled in fluid communication with a plurality of ice mold assemblies 304. Each ice mold assembly 304 includes a set of ice makers 334. Alcohol infused ice cubes generated by the ice makers 334 are stored in a bin housing associated with the sets of ice makers 334.

Alcohol infused ice cubes stored in each of the bin housings 330 is dispensed from the machine 300 via the dispensing system 306 and a common drop tray 308 that directs the alcohol infused ice cubes out of the machine via the dispense shoot channel 360. In other arrangements, a separate drop shoot channel 360 can be associated with each of the individual bin housings 330 or any number of the bin housings 330 as desired.

Machine 300 is shown including four separate bin housings 330, each being associated with a separate set of ice makers 334. Each of the ice makers 334 receives a mixture of alcohol and solution that is mixed in the mixing chamber 374. The mixing chamber 374 can be in fluid communication with each of the alcohol inputs 372. The mixing chamber 374 can be used to mix any combination of the solution input 370 and the alcohol inputs 372, or any one of those inputs 370, 372 alone. For example, the mixing chamber 374 can be used to mix the solution input 370 with just one of the alcohol inputs 372. In another example, three of the alcohol inputs 372 can be mixed in the mixing chamber 374. In another example, the mixing chamber 374 can act as a pass through device wherein a single one of the inputs 370, 372 alone can be directed to at least one of the ice makers 334.

The mixing distribution system 312 can include a valving arrangement 375 in fluid communication with any one or all of the mixing chamber 374, the solution and alcohol inputs 370, 372, and the mixture outputs 378. The valving arrangement 375 can be used to control the various fluid flows such as, for example, directing fluid to any one of the sets of ice makers 334 at a given time. The valving arrangement 375 can be configured to promote emptying of the mixing chamber 374 prior to initiating the mixing of a new mixture. Other valving devices and features are possible within the mixing and distribution system 312 to provide optimum flow control and mixing of various input fluids and directing those mixtures of fluids to the ice makers 334 to generate ice cubes such as alcohol infused ice cubes.

FIG. 16 illustrates an example drop tray configuration 308 that collects alcohol infused ice cubes from each of the dispensing systems 306 and dispenses the ice cubes from the dispense shoot 360. Many other drop tray configurations are possible.

FIGS. 17 and 18 illustrate top views of the mixing and distribution system 312 (FIG. 17) and the combination of a top cover 320 of the machine 300 with the system 312 (FIG. 18). The system 312 may include a lid member 313 that provides access to the mixing chamber 374 and other components of the mixing and distribution system 312. The cover 320 can also be removable to expose other features internal to the machine 300.

The machine 300 can further include a control system (not shown) that is used to control at least one function of the machine 300. The control system can be operated using a control panel, switches, actuators, or other user interface.

### The Example of FIGS. 19-22

FIGS. 19 and 20 illustrate another example alcohol infused ice machine 400. Machine 400 includes a cooling device 402, a plurality of ice mold assemblies 404, a drop tray 408, and a mixing and distribution system 412. The system 412 includes a mixing solution input 470, a plurality of alcohol inputs 472, and a mixture output 478 that is coupled to the plurality of ice mold assemblies 404. The mixing and distribution system 412 includes many of the same features as discussed above related to machine 300.

The machine 400 includes four separate bin housings 430 and a set of ice makers 434 associated with each bin housing 430. The bin housings 430 are stacked in pairs. Ice cubes generated by the ice makers 434 can be directed by the drop tray 408 to a dispense shoot channel 460 associated with each bin housing 430. In some arrangements, a control mechanism can be provided at the channel 460 to control the flow of ice cubes from the bin housings 430 out of the machine 400. Any of the same features or functionality of the dispensing system 106 described above can be included at or near the dispenser shoot channel 460.

The mixing and distribution system 412 can include a valving arrangement 475 that optimizes flow control, mixing, and dispensing of liquids to the ice makers 434. FIG. 19 illustrates fluid communication between the upper and lower sets of ice makers 434 for adjacent bin housings 430. As a result, these of bin housings 430 and associated ice makers 434 could be used to produce and store ice cubes having the same percentage alcohol content. The ice makers 434 shown in FIG. 19 could be configured to produce different shapes or sizes of ice cubes. Furthermore, one of the icemakers 434 shown in FIG. 19 could produce crushed ice while the other set of ice makers produce ice cubes. A single machine 400 can be used to produce ice cubes of various configurations, ice cubes of the same or different percentage alcohol content, or different mixtures of fluid (i.e., the same percentage alcohol content but based on different alcohol and mixing solution inputs).

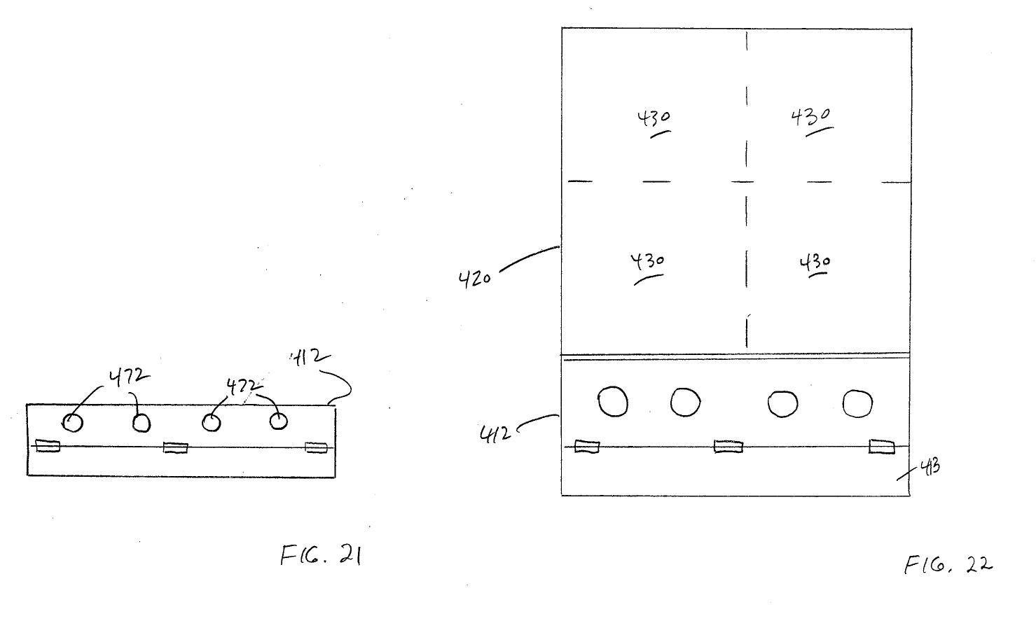

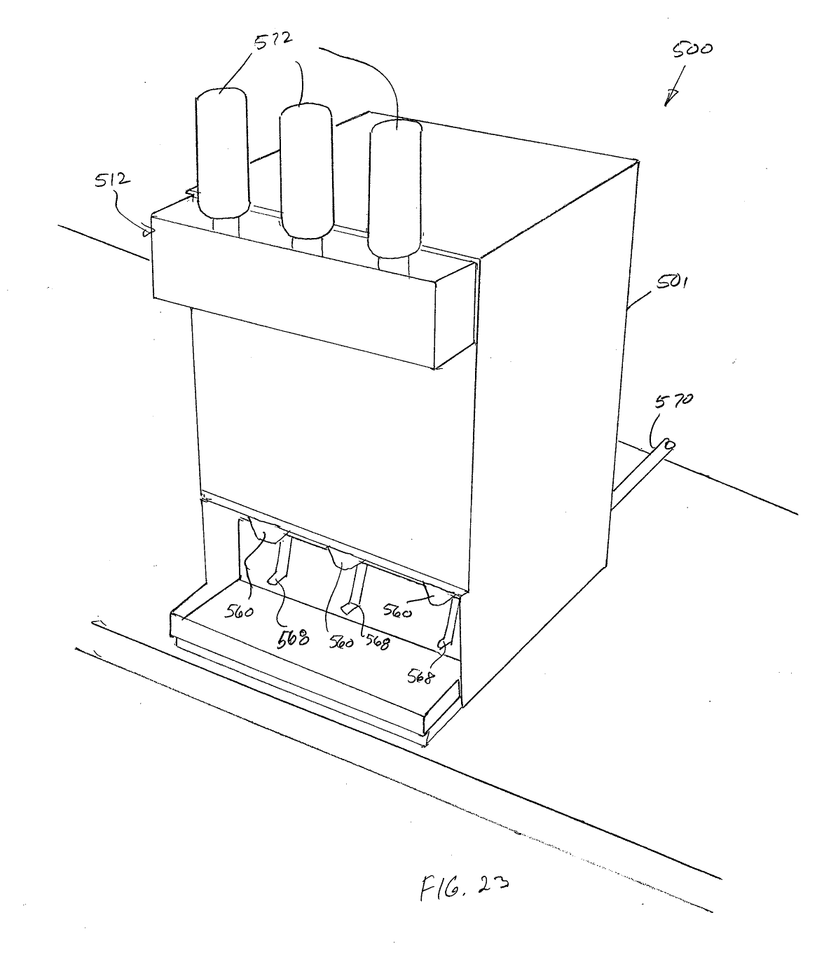

FIG. 21 illustrates a top view of the mixing and distribution system 412 alone. FIG. 22 illustrates a top view of a combination of a cover 420 with the mixing and distribution system 412. The system 412 can include a lid member 413 that provides access to the mixing chamber 474 and other features of the system 412. Likewise, the cover member 420 can be removed to access other features of the machine 400 such as the ice makers 434 and bin housings 430.

The machine 400 can further include a control system (not shown) that is used to control at least one function of the machine 400. The control system can be operated using a control panel, switches, actuators, or other user interface.

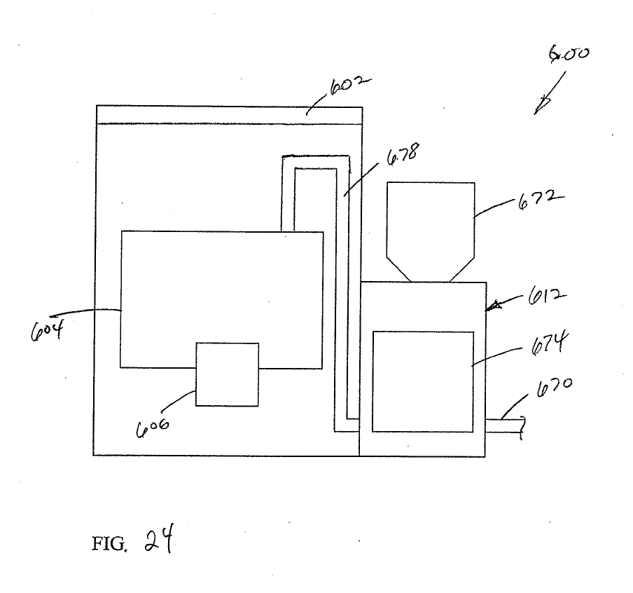

### The Example of FIG. 23

FIG. 23 is a perspective view illustrating another example alcohol infused ice machine 500. The ice machine 500 includes a housing 501 within which is positioned a cooling device and ice mold assembly (not shown). The machine 500 includes a mixing and distribution system 512 and a dispensing system that includes a plurality of dispense shoot channels 560 and a dispensing controller 568 associated with each channel 560. A solution input 570 provides a solution that can be mixed with any one of the alcohol containers 572 via the mixing and distribution system 512.

Other types of housing structures and configurations 501 can be used with any of the machines 10, 100, 200, 300, 400 described above to provide an aesthetically pleasing, functional alcohol infused ice cube machine for generating and dispensing alcohol infused ice cubes.

### The Example of FIG. 24

FIG. 24 illustrates another example alcohol infused ice machine 600. The machine 600 includes a cooling device 602, an ice mold assembly 604, a dispensing system 606, a mixing and distribution system 612 having a solution input 670, an alcohol input 672, and a mixture output 178 that is coupled to the ice mold assembly 604. The alcohol container 170 is a single source of alcohol that mixes with a single source of solution 670 in a single mixing chamber 674 of the system 612 to produce a solution/alcohol mixture 678 with desired percentage alcohol content.

The cooling device 602, ice mold assembly 604, and dispensing system 606 can be of any desired size and shape, and be positioned at any location relative to the system 612. For example, the system 612 can be position in one room and the cooling device 602, ice mold assembly 604, and dispensing system 606 can be position in a remote location such as a separate room. The cooling device 602 preferably provides a refrigerated environment of at least 0° to about 30° F., and more preferably about −5° to about −20° F. to freeze solid the solution/alcohol mixture 678.

### CONCLUSION

One aspect of the present disclosure relates to an alcohol infused ice cube machine, or an ice making machine that is adapted and configured to generated alcohol infused ice cubes. The machine can include at least one ice mold configured to generate alcohol infused ice cubes, at least one ice cube storage bin configured to collect alcohol infused ice cubes formed in the ice mold, a dispenser mechanism, a mixing arrangement, and a cooling mechanism. The dispenser mechanism is configured to dispense the alcohol infused ice cubes from the at least one ice cube storage bin. The mixing arrangement is configured to provide a mixture of alcohol and mixing solution to the at least one ice mold. The mixture typically contains at least 2% alcohol. In some arrangements, the alcohol content is at least 5%, and more preferably in the range of about 5% to about 80%. The cooling mechanism is configured to provide a refrigerated environment for the mixture in the at least one ice mold in the range of about 0° F. to about −60° F. The refrigerated environment is more preferably in the range of about −5° F. to about −20° F.

Another aspect of the present disclosure relates to an alcohol infused ice cube machine that includes a cooling mechanism, a mixing arrangement, at least one ice mold, at least one ice cube storage bin, a dispenser mechanism, and a control system. The cooling mechanism is configured to provide a refrigerated environment in the range of about 0° F. to about −30° F. The mixing arrangement is configured to provide a mixture that includes an alcohol beverage, wherein the mixture contains at least 2% alcohol. The mixing arrangement includes at least one mixing chamber configured to mix a volume of the alcohol beverage with at least one other liquid. The at least one ice mold is configured to receive a portion of the mixture to generate alcohol infused ice cubes. The at least one ice cube storage bin is configured to collect alcohol infused ice cubes generated in the ice mold. The dispenser mechanism is configured to dispense the alcohol infused ice cubes from the at least one ice cube storage bin. The control system is configured to control the dispensing mechanism and the mixing arrangement.

Another aspect of the present disclosure relates to methods of making alcohol infused ice cubes. One example method includes supplying a mixture of mixing solution and alcohol to an ice making machine, providing a freezing or refrigerated environment to the ice making machine, the freezing environment having a temperature of no greater than about 0° F., freezing the mixture into solid alcohol infused ice cubes with the ice making machine, and dispensing the alcohol infused ice cubes. The supplying step can also include mixing a source of the mixing solution with at least one source of the alcohol to create the mixture. The mixture can include at least two sources of alcohol. Dispensing the alcohol infused ice cubes can include determining the number of cubes dispensed in a dispense cycle. Many other steps and combinations of steps are possible.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An alcohol infused ice cube machine, comprising:
(a) at least one ice mold configured to generate alcohol infused ice cubes;
(b) at least one ice cube storage bin configured to collect alcohol infused ice cubes formed in the ice mold;
(c) a dispenser mechanism configured to dispense the alcohol infused ice cubes from the at least one ice cube storage bin;
(d) a mixing arrangement configured to provide a mixture of alcohol and mixing solution to the at least one ice mold, the mixture having an at least 20% alcohol content; and
(e) a cooling mechanism configured to provide a refrigerated environment for the mixture in the at least one ice mold of 0° F. or colder, thereby solidly freezing the alcohol infused ice cubes.

2. The machine of claim 1, wherein the mixing arrangement includes a mixing chamber wherein a volume of the alcohol and a volume of the mixing solution are combined to create the mixture.

3. The machine of claim 1, further comprising a control device configured to control the amount of alcohol infused ice cubes dispensed by the dispensing mechanism in a dispense cycle.

4. The machine of claim 1, wherein the mixing arrangement includes at least four mixing chambers and at least four different sources of alcohol, and generates at least four different mixtures of the mixing solution and at least one of the sources of alcohol.

5. The machine of claim 1, including at least first and second ice molds and at least first and second ice cube storage bins.

6. The machine of claim 5, wherein the mixing arrangement is configured to provide a different mixture to each of the ice molds.

7. The machine of claim 1, wherein the alcohol is provided to the mixing chamber under a gravity pressure condition.

8. The machine of claim 1, further includes an ice removing mechanism, the ice removing mechanism configured to remove ice cubes from the ice mold.

9. The machine of claim 1, wherein the cooling mechanism is configured to provide a refrigerated environment for the mixture in the ice mold in the range of −10° F. to −20° F.

10. The machine of claim 1, wherein the mixture contains at least 40% alcohol content.

11. The machine of claim 1, wherein the alcohol is an alcoholic beverage and the mixing solution is water.

12. A method of making ice cubes having an alcohol infused content, the method comprising:
(a) supplying a mixture of mixing solution and alcohol to an ice making machine, the mixture having an at least 20% alcohol content;
(b) providing a refrigerated environment to the ice making machine, the freezing environment having a temperature of no greater than 0° F.;
(c) freezing the mixture into solid alcohol infused ice cubes with the ice making machine; and
(d) dispensing the alcohol infused ice cubes.

13. The method of claim 12, wherein supplying the mixture includes mixing a source of the mixing solution with at least one source of the alcohol to create the mixture.

14. The method of claim 13, wherein the mixture includes at least two sources of alcohol.

15. The method of claim 12, wherein the ice cubes have a volume of at least 1 cubic centimeter.

16. The method of claim 12, wherein dispensing the alcohol infused ice cubes includes determining the number of cubes dispensed in a dispense cycle.

17. The method of claim 12, wherein dispensing the alcohol infused ice cubes includes directing the alcohol infused ice cubes from at least two different ice cube storage bins to a single dispensing opening.

18. The method of claim 12, wherein freezing the mixture includes delivering a volume of the mixture to at least one ice mold, the ice mold being exposed to the freezing environment.

19. An alcohol infused ice cube machine, comprising:
(a) a cooling mechanism configured to provide a refrigerated environment in the range of 0° F. to −30° F.;
(b) a mixing arrangement configured to provide a mixture that includes an alcohol beverage, the mixture having an at least 20% alcohol content, the mixing arrangement including at least one mixing chamber configured to mix a volume of the alcohol beverage with at least one other liquid;
(c) at least one ice mold configured to receive a portion of the mixture to generate solid alcohol infused ice cubes by exposure to the refrigerated environment;
(d) at least one ice cube storage bin configured to collect alcohol infused ice cubes generated in the ice mold;
(e) a dispenser mechanism configured to dispense the alcohol infused ice cubes from the at least one ice cube storage bin; and
(f) a control system configured to control the dispenser mechanism and the mixing arrangement.
